(19) United States
(12) Patent Application Publication
(10) Pub. No.: US 2006/0203609 A1
(43) Pub. Date: Sep. 14, 2006

(54) Apparatus for preparing liquid silicone elastomers of uniform composition and hue

(76) Inventors: David Lloyd Danielson, Midland, MI (US); Christopher Cummings Shirk, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/552,240

(22) PCT Filed: Mar. 25, 2004
(86) PCT No.: PCT/US04/09210

§ 371 Date: Oct. 7, 2005

(30) Foreign Application Priority Data
Jun. 2, 2003 (US) 60475164

(51) Int. Cl. B01F 15/02

(52) U.S. Cl. 366/162.1

(57) ABSTRACT

An apparatus for continuously preparing viscous compositions containing additives includes: (i) a mixing device for uniformly mixing and dispersing an additive into a viscous fluid; (ii) one or more servo motor driven pumps for feeding the viscous fluid to the mixing device; (iii) one or more servo motor driven pumps for feeding the additive to the mixing device; (iv) means for supplying the viscous fluid to the viscous fluid servo motor driven pumps; (v) means for supplying the additive to the additive servo motor driven pumps; (vi) means for dispensing a viscous composition containing the fluid and the additive from the mixing device into a container, (vii) a programmable logic computer, constructed and arranged to control the operation of the servo motor driven pumps for the viscous fluid and the servo motor driven pumps for the additive, so that a predetermined ratio of RPM between the servo motor driven pumps for the viscous fluid and the servo motor driven pumps for the additive, is maintained irrespective of pressure surges in the supply means for the viscous fluid and supply means for the additive; and (viii) a temperature compensation algorithm for compensating fluctuations in temperature of the viscous fluid.

This invention relates to an apparatus capable of continuously providing consistent amounts of pigments or other additives in elastomeric compositions, so that the same color and/or uniformity in the elastomeric compositions can be obtained, regardless of the presence of pressure surges in feed lines of elastomer bases, pigments, or additives, used in formulating elastomers. In particular, the apparatus embodies at least two pumps which are each synchronized by a computer, so that individual pumps will rotate at fixed rpm ratios with respect to one another, regardless of flow rates or pressure surges which occur from time to time in their respective feed lines.

Silicones as a class of materials, include certain compositions which are liquid elastomers. These liquid silicone elastomers generally consist of (i) sealant compositions which are used in the building and construction industry, commercial and consumer sealing applications, and (ii) liquid silicone rubber (LSR) compositions used in injection molding for producing fabricated parts.

Liquid silicone rubbers (LSR) are commercially prepared in 4-5 drum capacity quantities using large batch mixing pots. Upon completion of the mixing operation, the large mixing pots are transferred to straining, de-airing, and packaging systems, where the large mixing pots are unloaded, and their contents transferred to a fifty-five gallon drum or a five gallon pail. Since the large mixing pots and other components of the straining, de-airing, and packaging systems cannot be easily cleaned, it is necessary to avoid introducing additives such as pigments, into the large mixing pots during the compounding process, since pigments foul the equipment, rendering the large mixing pots unsuitable for use in the next compounding process.

For example, U.S. Pat. No. 5,332,313 (Jul. 26, 1994) and U.S. Pat. No. 5,547,000 (Aug. 20, 1996) represent the general state of the art regarding apparatus for mixing and dispensing of colored sealant compositions, the prior art including these patents do not disclose apparatus embodying concepts according to this invention.

Thus, the present invention provides an apparatus which utilizes less equipment and less steps, stages, and operations, whereby additives can be added and used to color liquid elastomeric compositions, without encountering disadvantages associated with the prior art systems, i.e., fouling of equipment used in mixing liquid elastomeric base compositions with color additives. As a result, the labor intensive steps of compounding, straining, de-airing, pigmenting, and packaging occurring after addition of the additives, are no longer required. Consequently, mixing and coloring of liquid elastomers can be obtained in a more efficient manner in a much simpler apparatus, enabling the production of colored or modified elastomeric products in a single stage before the elastomeric product enters a final container package.

The invention is directed to apparatus for the continuous preparation of viscous compositions containing medium to high viscosity fluids and an additive. The characteristic features and components of the apparatus include: (i) a mixing device for uniformly mixing and dispersing an additive, such as a color additive, into a viscous, medium to high viscosity fluid; (ii) one or more servo motor driven pumps for feeding the viscous, medium to high viscosity fluid to the mixing device; (iii) one or more servo motor driven pumps for feeding the additive to the mixing device; (iv) means for supplying the viscous, medium to high viscosity fluid to the viscous, medium to high viscosity fluid servo motor driven pumps; (v) means for supplying the additive to the additive servo motor driven pumps; (vi) means for dispensing a viscous composition containing the medium to high viscosity fluid and the additive from the mixing device into a container; (vii) a programmable logic computer, being so constructed and arranged to control the operation of the servo motor driven pumps for the viscous, medium to high viscosity fluid and the servo motor driven pumps for the additive, such that a predetermined ratio of RPM between the servo motor driven pumps for the viscous, medium to high viscosity fluid and the servo motor driven pumps for the additive, is maintained irrespective of pressure surges in the supply means for the viscous, medium to high viscosity fluid and the supply means for the additive; and (viii) temperature compensation algorithm means for compensating for any fluctuations in the temperature of the viscous, medium to high viscosity fluid.

Preferably, the viscous composition is a polydiorganosiloxane having a viscosity of 500 Pa·s (500,000 centistoke) to 3,000 Pa·s (3,000,000 centistoke) measured at 25° C., and the additive is an inorganic pigment, an organic pigment, a catalyst mixture, or other liquid additive capable of modifying the physical properties of viscous compositions.

These and other features of the invention will become apparent from a consideration of the detailed description.

### DRAWINGS

FIG. 1 is a simplified functional representation showing the flow pattern through an apparatus embodying the concepts of the present invention.

FIG. 2 is a pictorial representation of the apparatus in FIG. 1 showing more details of the construction of the apparatus.

### DESCRIPTION

Liquid silicone rubber compositions generally contain a polydiorganosiloxane, a filler, a cross-linking agent, and a curing catalyst. Liquid silicone rubbers are sold in 2-part kits, and are cured by exposure to heat. Liquid silicone rubbers are viscous materials and their consistency is toothpaste-like. Because liquid silicone rubbers are injection molded or cast into various fabricating components and parts, aesthetics such as color, hue, and physical properties, are important considerations. Therefore, liquid silicone rubber compositions with a variety of colors and hues are needed commercially, and matching colors for a specific application can often be a problem.

Liquid silicone rubber compositions are well know in the art, and reference may be had, for example, to U.S. Pat. No. 5,789,084 (Aug. 4,. 1998), considered incorporated herein by reference. Such compositions typically consist of (i) a liquid silicone rubber (Part A) base, and (ii) a liquid silicone rubber (Part B). Part A is generally a polydiorganosiloxane containing reactive groups such as alkenyl groups, and a pre-treated and hydrophobed filler. Part B generally consists of an organohydrogenpolysiloxane as the crosslinking agent, a platinum catalyst, as well as other additives such as adhesion promoters and tack inhibitors. Cured liquid silicone rubber compositions are prepared by mixing Parts A and B, and heating the mixture. The liquid silicone rubber (Part A) base constitutes the major portion of liquid silicone rubber compositions. Some examples of useful fillers for Part (A) include hexamethyldisilazane treated silica, finely divided calcium carbonate, titanium dioxide, quartz, diatomaceous earth, and alumina.

Since the polydiorganosiloxane and filler mixture in liquid silicone rubber bases is generally either clear or white, coloring agents are often added to the Part A base. While liquid silicone rubbers can be clear or white, they are usually prepared in about five to eight standard colors, including black, and various tones of beige, brown, or gray. However, virtually any color or hue is possible, subject to the reproducibility of the pigment, the exactness of metering, and the thoroughness of mixing. The coloring agents generally include the various categories of inorganic and organic pigments. In addition, other modifying agents are often needed and added to the liquid silicone rubber to enhance its thermal properties, change or alter its cure characteristics, or add lubricity.

The most important inorganic coloring agents employed in liquid silicone rubbers are generally derived from iron oxide pigments such as yellow, brown, red, and black iron oxides. Other synthetic inorganic pigments include cadmium orange, chromium oxide green, manganese violet, and molybdate orange. Numerous varieties of organic synthetic coloring agents include Acid Red 52, Benzidine Yellow HR, Methyl Violet, Phthalocyanine Green, Phthalocyanine Blue, Pigment Brown 28, and Victoria Blue B. To facilitate processing, the coloring agent is added to the liquid silicone rubber base in the liquid state. Pigment dispersions, color concentrates, and liquid colorants, are prepared by dispersing the pigment in a liquid carrier which typically comprises a polydimethylsiloxane polymer.

The apparatus according to the invention consists of a servo-assisted positive displacement metering apparatus for accurately metering liquid pigments and/or other types of additives, into streams of medium to high viscosity fluids. In an especially preferred embodiment, the apparatus relates to metering and mixing pigments into base compositions used in formulating liquid silicone rubbers.

More particularly, the apparatus according to the invention consists of at least two servo motor driven and servo-controlled metering gear pumps which pump a single liquid silicone rubber base and one or more additives such as a pigment(s) through a mixing device. Colored liquid silicone rubber bases are discharged from the mixing device into a pail or drum. Suitable mixing devices include for example dynamic mixers of the type described in U.S. Pat. No. 5,332,313 (Jul. 26, 1994), although any dynamic mixing device can be employed.

Servo-motors are well known in the electromechanical arts, and with the aid of regulator components, such motors can be controlled, so that rotation can be provided in any desired direction, at controlled rates of acceleration, velocity, and with any number of revolutions or parts of revolutions. Servo-motors are available commercially under names such as Allen-Bradley®, a type manufactured by Rockwell Automation, Milwaukee, Wis. Typically, servo motors include other components such as resolvers, encoders, and tachometers. The motors can be AC motors, DC motors, or of brushless construction.

In this invention, the base metering pump functions as a power assisted gear meter, allowing accurate metering, while being sensitive to changes in upstream flow conditions. This is accomplished by operating the base servo in a constant torque mode, in order to overcome static friction losses of the base pump and drive gear reducer (box). As a result, there is provided a relatively low-pressure base stream from the upstream process which typically only generates less than about 150 psi (1,035 kPa) of back-pressure, to drive the base pump at a rate consistent with the flow rate of the stream.

The resolver on the base servo motor then transmits the driven speed of the base motor to a programmable logic controlling computer, whereby the pigment/additive pump rate will be set based on the desired mixing ratio. Since the base can be discharged from upstream processes at various temperatures, a temperature compensation loop is programmed into the ratio control in order to compensate for any volume changes in the base. This is accomplished by means of a temperature indicator on the base supply. Liquid elastomeric bases usable in the apparatus, particularly LSRs, generally have large coefficients of thermal expansion. Therefore, it is necessary in this regard to measure the temperature, and to use the data to insure a proper mass-volume relationship during the metering process.

Thus, the primary focus of the invention an apparatus which includes a computer to synchronize the rpm ratio of two or more pumps, in order to consistently provide uniform liquid silicone rubber compositions. The pumps are synchronized so that they always rotate at the same fixed rpm ratio, one with respect to the other, regardless of variation in flow rates of the base and pigment occurring from time to time in respective feed lines. As can be seen in the accompanying examples, one particularly effective ratio was 1:2.333 of base to pigment.

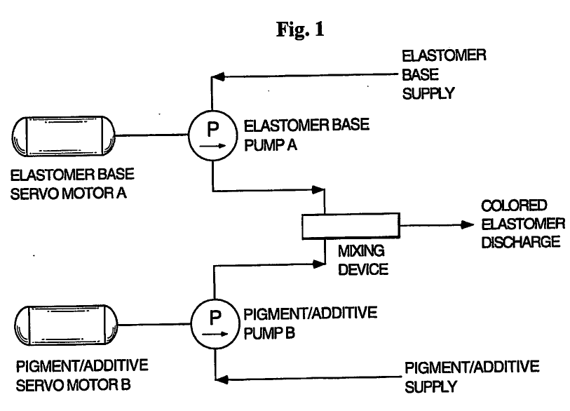

With reference to FIG. 1 of the drawing, there can be seen a simplified pattern of flow of materials through the apparatus. Thus, the elastomer base and pigment/additive components are supplied to the mixing device by means of two separate systems of servo motor driven pumps. Pump A is driven by the flow of the upstream process, and is assisted by servo motor A. Pump B is driven by servo motor B and supplies pigment/additive to the mixing device. The discharge from the mixing device is the desired colored elastomer.

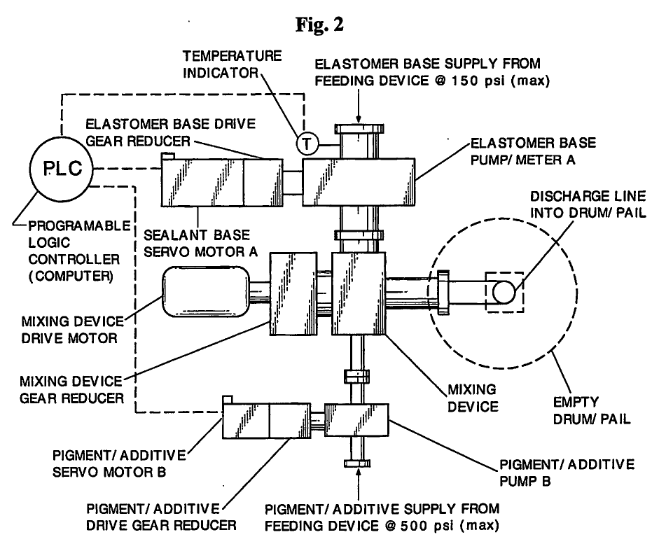

As can be seen in FIG. 2, the elastomer base is supplied to the apparatus under a pressure generally less than about 150 psi (1,035 kPa), from a suitable feeding device (not shown). The elastomer base is supplied to the mixing device by means of elastomer base pump A. Elastomer base pump A is driven via the elastomer base drive gear reducer, by elastomer base servo motor A. The mixing device includes a mixing device gear reducer and a mixing device drive motor.

Pigment/additive is supplied to the apparatus under a pressure generally less than about 500 psi (3,450 kPa), from a suitable feeding device (not shown). The pigment/additive is supplied to the mixing device by means of a pigment/additive pump B. Pigment/additive pump B is driven via a pigment/additive drive gear reducer, by pigment/additive servo motor B. A discharge line from the mixing device conveys colored elastomer from the mixing device into an empty drum for pail.

Temperature indicator T in the feed line of elastomer base senses the temperature of elastomer base in the line, and the recorded temperature is monitored by the programmable logic controller computer (PLC). A temperature compensation algorithm functions to compensate for any fluctuations in temperature of the elastomer base. The PLC is connected to monitor, control, and adjust the operation of the elastomer base servo motor A and the pigment/additive servo motor B with respect to one another, at any instant in time.

Absent occurrence of pressure or flow rate surges in one, or the other, or both, of the feed lines of elastomer base and pigment/additive, no adjustment is required. Should a pressure or flow rate surge occur in one, or the other, or both, of the feed lines of elastomer base and pigment/additive, then the PLC automatically adjusts the speed of rotation of the pigment/additive motor B, in order to maintain the predetermined ratio of RPM between the elastomer base servo motor A and pigment/additive servo motor B. Predetermined ratios of RPM of the elastomer base servo motor A and the pigment/additive servo motor B will vary from 1:1, and is a factor dependent upon the particular properties and characteristics of elastomer base and pigment/additive being used to formulate a given product, as well as the color and hue of the product desired. The PLC however is programmed to carry out these complex operations.

### EXAMPLES

In the example, the liquid silicone rubber base had a viscosity of about 3,000 Pa·s (3,000,000 centistoke). The coloring agent was an iron (II,III) black oxide pigment dispersed in a compatible polysiloxane fluid.

A laboratory prototype apparatus for carrying out the example consisted of several units mounted on skids for ease in movement. The apparatus included (i) a pair of positive displacement pumps, (ii) a mixing device generally of construction as shown in U.S. Pat. No. 5,332,313, (iii) an external drum discharge line for filling drums and/or pails, and (iv) a control panel containing the necessary electrical and control hardware required for operating the apparatus.

Drum pumps manufactured by Graco® Inc., Minneapolis, Minn., were used to feed liquid silicone rubber bases into the apparatus, although any standard drum pump, pot press, or direct feed from a compounders or de-airing device can be used. These pumps were mounted on loss-in-weight scales for determining the occurrence of experimental errors.

The main control system consisted of an Allen-Bradley® SLC processor coupled with a Panelview® operator interface. The system included a main SLC processor module, an Input/Output (I/O) adapter module, an I/O chassis, I/O modules, communication modules, and a power supply.

The servo motor A for pumping elastomer base and the servo motor B for pumping pigment/additive were driven by an Allen-Bradley® servo drive system. The mixing device was driven by an Allen-Bradley® variable frequency drive (VFD). These systems were all designed to communicate with one another by means of an Allen-Bradley® remote I/O which facilitated their programming. A Daisy Labs brand data acquisition software package was also a component of the system. It made it possible to display, trend, and evaluate digital and analogue data from the process. The PLC was then enabled to monitor all of the various process parameters.

The following specific example illustrates the invention in more detail.

### Example

An experimental formulation was prepared consisting of (i) about 97.0 percent by weight of a commercially available liquid silicone rubber (Part A) base composition having a viscosity of about 3,000 Pa·s (3,000,000 centistoke), and (ii) about 3.0 percent by weight of a pigmented polydimethylsiloxane carrier fluid having a viscosity of about one Pa·s (1,000 centistoke). The base was fed to apparatus of the type shown in FIG. 2 from a Graco® drum pump, with pressure and flow surges to simulate typical upstream liquid silicone rubber production process outputs. The pigment was fed to the apparatus by a Graco® pail pump at a consistent rate, to provide flooded suction to the servo controlled pigment pump, also a typical situation encountered during production.

To test the accuracy of the system, actual metered amounts were measured by loss-in-weight of the Graco® feed pumps, and gain-in-weight measurement made by collecting the base and pigment in separate cups and weighing them. During the process, the elastomer base supply feed was assisted by elastomer base servo motor in a constant torque mode, allowing the Graco® elastomer base pump to drive the elastomer base feed pump with a minimal loss in pressure. The resolver component of the elastomer base servo motor reported instantaneous speeds of the elastomer base pump back to the PLC. The PLC then used the signals to determine the subsequent rate of the pigment supply feed pump factored by a pre-caculated RPM ratio, to obtain the proper mix ratio. Metered elastomer base and pigment were then pumped into the mixing device and discharged into a drum. Based on predetermined calculations, the most desirable pump RPM ratio was 1:2.333 of elastomer base to additive. This ratio was programmed into the PLC.

The Graco® feed pump pumped at approximately 15 kg/min and drove the elastomer base pump A at approximately 20 rpm with surges of 10-30 rpm. The back-pressure on the elastomer base pump A was 100 psi (690 kPa), confirming that the associated servo motor was indeed assisting the product flow through the elastomer base pump. Pigment pump B moved in concert with the elastomer base pump A, thereby maintaining the desired ratio of 1:2.333. The respective rpms of the two pumps were tracked and recorded by a LabView® software package from National Instruments Corporation, Austin, Tex. This graphical programming language for data acquisition enabled programming in a way such that complex programs could be written in much less time and with much less effort. Table 1 includes the data showing that the desired ratio effect was achieved.

TABLE 1
Base and Additive RPM for the Experimental Base Formulation

| Time from Start, seconds | Base rpm | Additive rpm | Actual Ratio |
|---|---|---|---|
| 10 | 19 | 44 | 2.333 |
| 20 | 15 | 35 | 2.333 |
| 30 | 13 | 30 | 2.333 |
| 40 | 15 | 35 | 2.333 |
| 50 | 18 | 42 | 2.333 |
| 60 | 23 | 54 | 2.333 |
| 70 | 22 | 51 | 2.333 |
| 80 | 25 | 58 | 2.333 |
| 90 | 21 | 49 | 2.333 |
| 100 | 13 | 30 | 2.333 |
| 110 | 17 | 40 | 2.333 |
| 120 | 26 | 61 | 2.333 |
| 130 | 20 | 47 | 2.333 |
| 140 | 32 | 75 | 2.333 |
| 150 | 25 | 58 | 2.333 |
| 160 | 19 | 44 | 2.333 |
| 170 | 20 | 47 | 2.333 |
| 180 | 17 | 40 | 2.333 |

The loss-in-weight of the two components was then compared to determine what the mix ratio was over predetermiined time periods. These values were then compared with the desired mix ratio. The Results are shown in Table 2.

TABLE 2
Actual vs. Theoretical Mix Ratio of Experimental Base Formulation

| Time, | Base, | Pigment, | Target Base, | Actual Base, |
|---|---|---|---|---|
| minutes | kilogram | kilogram | Weight % | Weight % |
| 1 | 6.7 | 0.45 | 97.0 | 93.7 |
| 2 | 13.0 | 0.60 | 97.0 | 95.6 |
| 3 | 28.8 | 1.05 | 97.0 | 96.5 |
| 4 | 61.1 | 2.10 | 97.0 | 96.7 |
| 5 | 72.5 | 2.40 | 97.0 | 96.8 |
| 6 | 94.8 | 3.10 | 97.0 | 96.8 |
| 7 | 121.8 | 3.90 | 97.0 | 96.9 |
| 8 | 133.8 | 4.25 | 97.0 | 96.9 |
| 9 | 144.8 | 4.60 | 97.0 | 96.9 |
| 10 | 160.1 | 5.05 | 97.0 | 96.9 |
| 11 | 181.7 | 5.70 | 97.0 | 97.0 |
| 12 | 195.5 | 6.15 | 97.0 | 97.0 |
| 13 | 211.3 | 6.65 | 97.0 | 96.9 |
| 14 | 224.5 | 7.00 | 97.0 | 97.0 |
| 15 | 238.7 | 7.40 | 97.0 | 97.0 |
| 16 | 254.6 | 7.85 | 97.0 | 97.0 |
| 17 | 272.5 | 8.40 | 97.0 | 97.0 |
| 18 | 284.3 | 8.80 | 97.0 | 97.0 |
| 19 | 305.7 | 9.40 | 97.0 | 97.0 |
| 20 | 324.0 | 9.95 | 97.0 | 97.0 |
| 21 | 344.6 | 10.55 | 97.0 | 97.0 |
| 22 | 367.3 | 11.25 | 97.0 | 97.0 |
| 23 | 397.5 | 12.20 | 97.0 | 97.0 |
| 24 | 420.1 | 12.85 | 97.0 | 97.0 |

It can be seen that the final accuracy of the process was close to the formulated/Target Base amount, and within 0.1 percent after initial start up.

Other variations may be made in compounds, compositions, and methods described herein without departing from the essential features of the invention. The embodiments of the invention specifically illustrated herein are exemplary only and not intended as limitations on their scope except as defined in the appended claims.

1. Apparatus for continuously preparing compositions containing liquid elastomers and additives comprising: (i) a mixing device for uniformly mixing and dispersing an additive into a liquid elastomer; (ii) one or more servo motor driven pumps for feeding the liquid elastomer to the mixing device; (iii) one or more servo motor driven pumps for feeding the additive to the mixing device; (iv) means for supplying the liquid elastomer to the liquid elastomer servo motor driven pumps; (v) means for supplying the additive to the additive servo motor driven pumps; (vi) means for dispensing a composition containing the liquid elastomer and the additive from the mixing device into a container; (vii) a programmable logic computer so constructed and arranged to control the operation of the servo motor driven pumps for the liquid elastomer and the servo motor driven pumps for the additive, so that a predetermined ratio of RPM between the servo motor driven pumps for the liquid elastomer and the servo motor driven pumps for the additive, is maintained, irrespective of pressure surges in the supply means for the liquid elastomer and the supply means for the additive; and (viii) temperature compensation algorithm means for compensating fluctuations occurring in the temperature of the liquid elastomer.

2. Apparatus according to claim 1 in which the liquid elastomer comprises a polydiorganosiloxane having a viscosity of about 500 Pa·s (500,000 centistoke) to about 3,000 Pa·s (3,000,000 centistoke) measured at 25° C.

3. Apparatus according to claim 1 in which the additive is an inorganic pigment or an organic pigment.

4. Apparatus according to claim 1 in which the ratio of RPM between the servo motor driven pumps for the liquid elastomer and the servo motor driven pumps for the additive is about 1:2.333.
